(19) United States
(12) Patent Application Publication
(10) Pub. No.: US 2026/0034688 A1
(43) Pub. Date: Feb. 5, 2026

(54) LIVE WORKING ROBOT AND METHOD FOR MAINTAINING HIGH-VOLTAGE ELECTRICAL DEVICE

(71) Applicants: GUANGDONG POWER GRID CO., LTD., Guangzhou (CN); Heyuan Power Supply Bureau Of Guangdong Power Grid Corporation, Heyuan (CN)

(72) Inventors: Peijie LIU, Heyuan (CN); Tuo ZENG, Heyuan (CN); Dingji ZENG, Heyuan (CN); Junhui CHEN, Heyuan (CN); Wei SUN, Heyuan (CN); Guoliang LIU, Heyuan (CN); Long ZHANG, Heyuan (CN); Guohai ZENG, Heyuan (CN); Ben SU, Heyuan (CN); Hao HUANG, Heyuan (CN); Jiangfeng QIAO, Heyuan (CN)

(21) Appl. No.: 19/006,770

(22) Filed: Dec. 31, 2024

(30) Foreign Application Priority Data
Aug. 5, 2024 (CN) 202411065564.3

(51) Int. Cl. B25J 19/00; B25J 9/00; B25J 9/16

(52) U.S. Cl. CPC B25J 19/0075; B25J 9/0084; B25J 9/1664

(57) ABSTRACT

A live working robot includes a working bottom plate, three mechanical arms disposed on the working bottom plate, three insulating rods, a connection plate and a clamping member. The mechanical arms are disposed at intervals around a central axis of the working bottom plate, and the mechanical arms are provided with connection portions. The insulating rods and the mechanical arms are disposed correspondingly, one end of a three insulating rod is connected to a respective connection portion, and connection positions between the insulating rods and the connection portions are adjustable. One surface of the connection plate is provided with mounting members disposed at intervals around a central axis of the connection plate, the other ends of the insulating rods are connected to the mounting members in one-to-one correspondence, and each of the mounting members is movably connected to a respective insulating rod.

### CROSS-REFERENCE TO RELATED APPLICATION

This application claims priority to Chinese Patent Application No. 202411065564.3, filed Aug. 5, 2024, the disclosure of which is incorporated herein by reference in its entirety.

### TECHNICAL FIELD

The present disclosure relates to the technical field of electric power robots, and in particularly, to a live working robot and a method for maintaining a high-voltage electrical device.

### BACKGROUND

With the development of economy, requirements on continuous reliability of power supply are continuously increasing, and a power distribution network is required to achieve uninterrupted power transmission. In the power distribution network, an electrical device needs to be often tested, inspected and maintained during the long-term operation. A live working is an effective measure for avoiding the inspection and power failure and ensuring the normal power supply. The live working is a working method for detecting and maintaining a high-voltage electrical device on the premise of no power failure. In order to protect the safety of a worker, the existing live working is mostly completed by using a mechanical arm, and the mechanical arm is used to pick up a maintenance tool, and the high-voltage electrical device is maintained by manipulating the mechanical arm. In order to prevent damage of the mechanical arm due to touching a high-voltage device, in the related art, an insulating rod is mounted on the mechanical arm, and the maintenance tool is mounted to the insulating rod, so that the maintenance tool is manipulated by controlling the mechanical arm to maintain the high-voltage device. However, the insulating rod is made of an insulating material, the existing insulating material has a poor rigidity; therefore, when the worker controls the movement of the mechanical arm and maintains the high-voltage electrical device, the maintenance tool may be slightly shaken, thereby resulting in the poor maintenance accuracy of the high-voltage electrical device. In order to ensure the normal operation of power supply, the maintained high-voltage electrical device needs to be frequently maintained by the worker.

Therefore, there is an urgent need for a live working robot and a method for maintaining a high-voltage electrical device, to solve the above-described technical problems.

### SUMMARY

Embodiments the present disclosure provide a live working robot and a method for maintaining a high-voltage electrical device.

A live working robot includes a working bottom plate, three mechanical arms, three insulating rods, a connection plate and a clamping member. The three mechanical arms are disposed on the working bottom plate, the three mechanical arms are disposed at intervals around a central axis of the working bottom plate, and the three mechanical arms are provided with connection portions, respectively. The three insulating rods and the three mechanical arms are disposed in one-to-one correspondence. One end of each of the three insulating rods is connected to a respective one of the connection portions. Each of connection positions between the connection portions and the three insulating rods is adjustable. One surface of the connection plate is provided with three mounting members, the three mounting members are disposed at intervals around a central axis of the connection plate, the other ends of the three insulating rods are connected to the three mounting members in one-to-one correspondence, and each of the three mounting members is movably connected to a respective one of the three insulating rods. The clamping member is arranged on another surface of the connection plate and configured to clamp a maintenance tool.

In some embodiments, the connection portions are each a clamping claw; or the connection portions are electric rotary wheels, circumferential surfaces of the electric rotary wheels are provided with grooves respectively, each of the three insulating rods is arranged within a respective one of the grooves, and each of the electric rotary wheels is configured to perform a forward rotation and a reverse rotation.

In some embodiments, the live working robot further includes a control system, where the control system includes a first control member and a second control member, the first control member is configured to control movement of the three mechanical arms, and the second control member is configured to control movement of the connection portions.

In some embodiments, the working bottom plate is configured to perform a self-rotation movement.

In some embodiments, the working bottom plate includes a bottom plate, a driving member and a rotary plate, the driving member is arranged on the bottom plate, an output end of the driving member is connected to the rotary plate, and the three mechanical arms are disposed on the rotary plate.

In some embodiments, the mounting members are each a universal joint.

In some embodiments, the connection plate is in a regular triangle shape.

In some embodiments, the mechanical arms are each a six-degree-of-freedom mechanical arm.

In some embodiments, the live working robot further includes a surveillance camera, where the surveillance camera is arranged on the connection plate, and the surveillance camera and the clamping member are located on a same surface of the connection plate.

A method for maintaining a high-voltage electrical device includes the following steps that the maintenance tool is placed within the clamping member, and the clamping member is locked by using a locking member; the live working robot is placed onto a lifting platform, and the live working robot is moved around the high-voltage electrical device through the lifting platform; the first control member and the second control member are operated to control movement states of the mechanical arms and movement states of the connection portions, so that the maintenance tool performs a maintenance on the high-voltage electrical device; and after the maintenance is completed, the first control member and the second control member are operated again to keep the maintenance tool away from the high-voltage electrical device.

According to the method for maintaining the high-voltage electrical device provided in the present disclosure, the maintenance step is simple, the high-voltage electrical device can be maintained accurately, and thus the maintenance quality of the high-voltage electrical device can be ensured.

### BRIEF DESCRIPTION OF DRAWINGS

FIG. 1 is a schematic view of a first working posture of a live working robot according to the present disclosure;

FIG. 2 is a schematic view of a second working posture of a live working robot according to the present disclosure; and

FIG. 3 is a flowchart of a method for maintaining a high-voltage electrical device according to the present disclosure.

FIG. 4 is a schematic view of a third working posture of a live working robot according to one or more embodiments of the present disclosure.

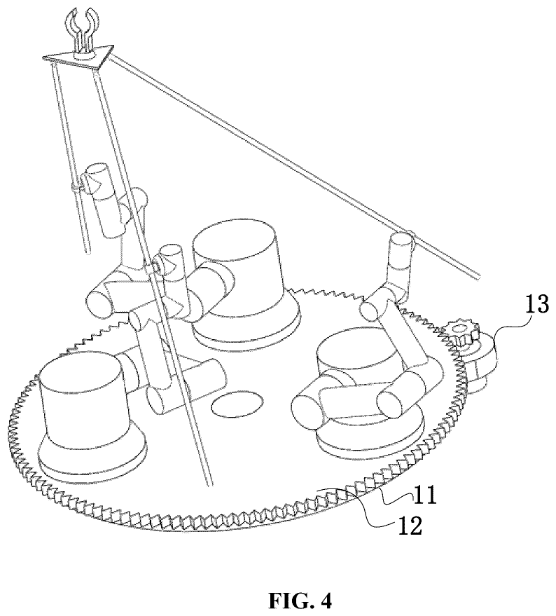

FIG. 5 is a schematic view of a fourth working posture of a live working robot according to one or more embodiments of the present disclosure.

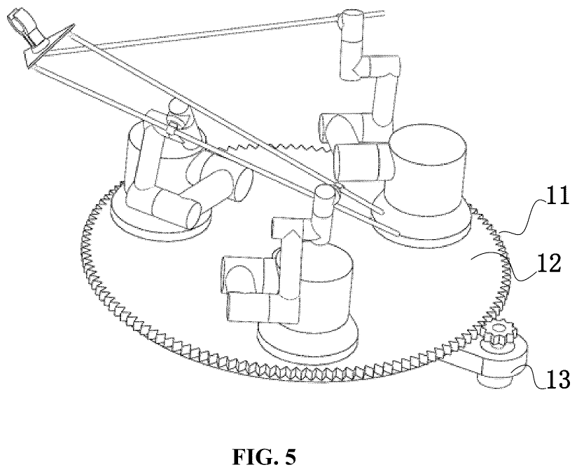

### LIST OF REFERENCE NUMBERS

1 working bottom plate
11 bottom plate
12 rotary plate
13 driving member
2 mechanical arm
21 connection portion
3 insulating rod
4 connection plate
41 mounting member
5 clamping member

### DETAILED DESCRIPTION

The present disclosure will be further described in detail in conjunction with the drawings and embodiments below. It is to be understood that the specific embodiments described herein are merely used for explaining the present disclosure and are not intended to limit the present disclosure. In addition, it is also to be noted that, for ease of description, only some, but not all, of the structures related to the present disclosure are shown in the drawings.

In the description of the present disclosure, unless otherwise expressly specified and limited, the term “connected to each other”, “connected”, or “fixed” is to be construed in a broad sense, for example, may mean securely connected, or detachably connected, or integrated; may mean mechanically connected or electrically connected; and may mean directly connected to each other, indirectly connected to each other via an intermediary, internal connection between two elements, or interaction between two elements. For those of ordinary skill in the art, specific meanings of the preceding terms in the present disclosure may be understood based on specific situations.

In the present disclosure, unless otherwise expressly specified and limited, a first feature being “on” or “under” a second feature may include the first feature and the second feature being in direct contact, or may include the first feature and the second feature not being in direct contact but being in contact with each other through an additional feature therebetween. Moreover, the first feature being “on”, “above” or “over” the second feature includes the first feature being directly on, above or over and obliquely on, above or over the second feature, or simply indicates that the first feature is at a higher level than the second feature. The first feature being “under”, “below” or “underneath” the second feature includes the first feature being directly under, below or underneath and obliquely under, below or underneath the second feature, or simply represents that the first feature is at a lower level than the second feature.

In the description of this embodiment, the orientation or position relationships indicated by terms “above”, “below”, “right”, and the like are based on the orientation or position relationships shown in the drawings, merely for ease of description and simplifying an operation, these relationships do not indicate or imply that the referred apparatus or element must have a specific orientation and is constructed and operated in the specific orientation, and thus it is not to be construed as limiting the present disclosure. In addition, the terms “first” and “second” are used only to distinguish between descriptions and have no special meaning.

### Embodiment One

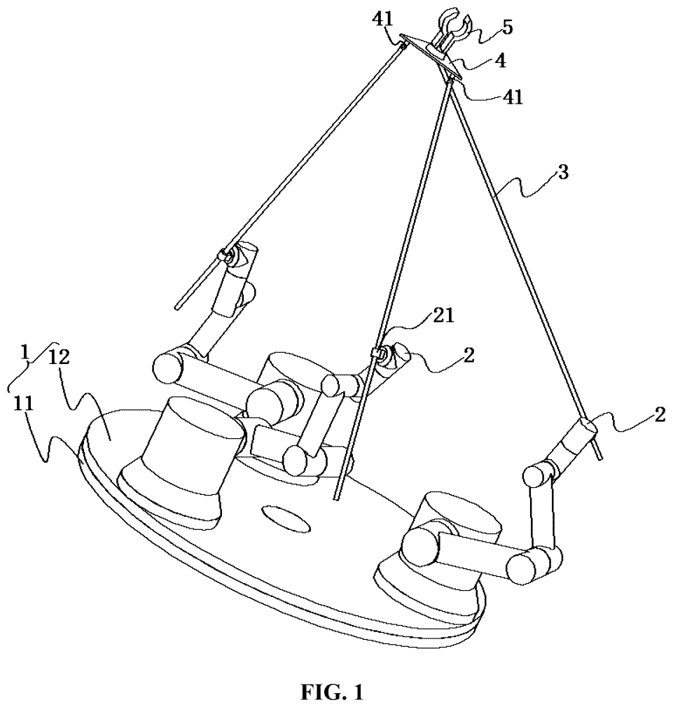

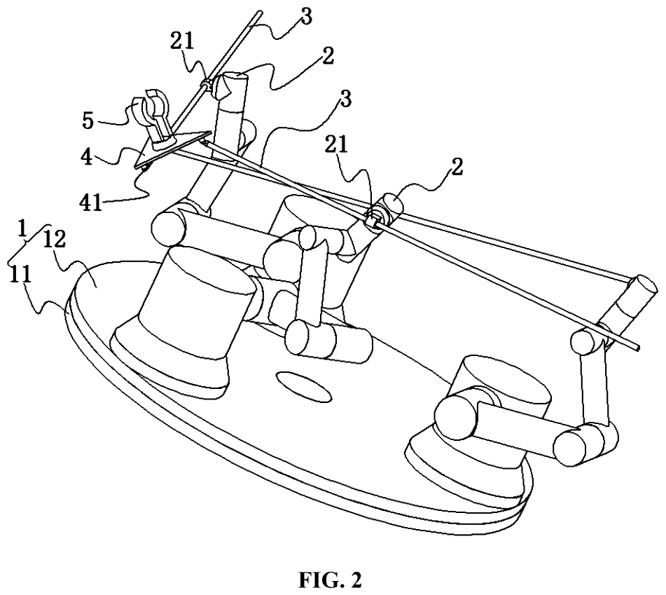

As shown in FIGS. 1 and 2, a live working robot provided in this embodiment includes a working bottom plate 1, mechanical arms 2, insulating rods 3, a connection plate 4 and a clamping member 5. The mechanical arms 2 are disposed on the working bottom plate 1, three mechanical arms 2 are provided, and the three mechanical arms 2 are disposed at intervals around a central axis of the working bottom plate 1, the three mechanical arms 2 are provided with connection portions 21 connected to the insulating rods 3, respectively. Three insulating rods 3 are provided, the three insulating rods 3 and the three mechanical arms 2 are disposed in one-to-one correspondence. One end of each of the three insulating rods 3 is connected to a respective one of the connection portions 21, and each of connection positions between the connection portions 21 and the three insulating rods 3 is adjustable. One surface of the connection plate 4 is provided with three mounting members 41, the three mounting members 41 are disposed at intervals around a central axis of the connection plate 4, the other ends of the three insulating rods 3 are connected to the three mounting members 41 in one-to-one correspondence, and each of the three mounting members 41 is movably connected to a respective one of the three insulating rods 3. The clamping member 5 is arranged on another surface of the connection plate 4 and is configured to clamp a maintenance tool. The embodiment solves the problems in the related art that when the high-voltage electrical device is maintained, a maintaining tool may shake, the maintenance accuracy of the high-voltage electrical device is poor, and thus the maintained high-voltage electrical device needs to be maintained frequently by the worker.

According to the live working robot provided in one or more embodiments, the three mechanical arms 2, the three insulating rods 3 and the three mounting members 41 are provided, so that when the live working robot is working, on the one hand, the three insulating rods 3 jointly support the connection plate 4, and thus the connection plate 4 is subjected to the stable force; therefore, when a worker controls the mechanical arm 2 to manipulate the maintenance tool, the degree of shaking of the maintenance tool is greatly reduced, and the maintenance accuracy of the high-voltage electrical device is improved; on the other hand, the insulating rod 3 is arranged between the mechanical arm 2 and the connection plate 4, and the mechanical arm 2 and the clamping plate have the effect of fixing the insulating rod 3 from two ends of the insulating rod 3, which also reduces the degree of shaking of the insulating rod 3 when the worker manipulates the maintenance tool by controlling the mechanical arm 2, and improves the maintenance accuracy of the high-voltage electrical device. The connection position between the connection portion 21 and the insulating rod 3 is enabled to be adjusted, and the insulating rod 3 is enabled to be movably connected to the mounting member 41, so that the height and the orientation of the connection plate 4 are adjustable, and further the height and the orientation of the maintenance tool are adjustable, whereby the live working robot has the relatively high degree of flexibility in use, is also maintained in a complex situation, and thus has the high universality.

In one or more embodiments, each of the connection portions 21 is a clamping claw. The clamping claw is electrically driven and is capable of being controlled to be opened or closed by an external remote control apparatus. When the connection position between the connection portion 21 and the insulating rod 3 needs to be adjusted, the worker only needs to remotely control the clamping claw to be opened, manipulate the mechanical arm 2 to adjust the clamping claw to a required position, and then remotely control the clamping claw to be closed, so that the connection position between the connection portion 21 and the insulating rod 3 is adjustable. In another embodiments, each of the connection portions 21 may be an electric rotary wheel capable of performing a forward rotation and a reverse rotation. The outer circumferential surface of the electric rotary wheel is provided with a groove, and the insulating rod 3 is placed within the groove. In this case, the forward rotation and reverse rotation of the electric rotary wheel are controlled so that the connection position between the connection portion 21 and the insulating rod 3 is adjustable, the orientation of the connection plate 4 is adjustable, and further the state of the maintenance tool is adjustable.

In one or more embodiments, the live working robot further includes a control system. The control system includes a first control member and a second control member, where the first control member is configured to control a movement of the mechanical arm 2, and the second control member is configured to control a movement of the connection portion 21. The worker controls a movement state of the mechanical arm 2 and a movement state of the connection portion 21 by remotely operating the first control member and the second control member, to remotely operate the maintenance tool to maintain the high-voltage electrical device, thereby avoiding the risk of the worker contacting the high-voltage electrical device, and protecting the safety of the worker while ensuring the completion of the maintenance work. The first control member and the second control member may be selected as a remote control handle capable of being controlled through infrared, or may be selected as a control panel capable of being controlled through communication, which is not specifically limited herein. Reference may be made to the related art for the specific structures and working principles of the infrared remote control handle and the communication control panel, which is not an improvement point of this embodiment and is not described herein again.

In one or more embodiments, the working bottom plate 1 is capable of performing a self-rotation movement, so that the action of the live working robot is more flexible. For some minor changing actions, the worker may complete these actions by only controlling the working bottom plate 1 to perform the self-rotation movement, thereby reducing the operation difficulty of the worker. With regard to the structure of the working bottom plate 1, exemplarily, the working bottom plate 1 includes a bottom plate 11, a driving member 13 and a rotary plate 12, where the driving member 13 is arranged on the bottom plate 11, an output end of the driving member 13 is connected to the rotary plate 12, the mechanical arm 2 is disposed on the rotary plate 12, the rotary plate 12 is controlled to be rotated by controlling the operation of the driving member, thereby driving the mechanical arm 2 to rotate, and achieving the action of the adjustment of the live working robot. The driving member 13 may be selected as a rotary motor, and may also be selected as a gear driving structure, as long as the rotary plate 12 can be rotated. The driving member 13 is not specifically limited herein. In one or more embodiments, the live working robot further includes a third control member, the third control member is configured to control the driving member 13 to operate, thereby further reducing the manipulation difficulty of the worker. An infrared remote control may be selected for the third control member.

In one or more embodiments, the mounting member 41 may be selected as a universal joint, so that the mounting member 41 is movably connected to the insulating rod 3. When the worker adjusts the connection position between the connection portion 21 and the insulating rod 3, the orientation of the insulating rod 3 is flexibly changed under the action of the mounting member 41, thereby ensuring the flexible change of the orientation of the connection plate 4, and ensuring the flexibility of action of the live working robot.

In one or more embodiments, the connection plate 4 is in a regular triangle shape, which facilitates the assembly of the mounting member 41, further improves the stability of the connection plate 4 under force, and reduces the degree of shaking of the insulating rod 3.

The mechanical arm 2 is a six-degree-of-freedom mechanical arm 2, to ensure that it drives the live working robot to complete more complex work, and further ensure the maintenance accuracy of the high-voltage electrical device. Of course, according to the requirement of the operating environment, the mechanical arm 2 may also select as a three-degree-of-freedom mechanical arm or a seven-degree-of-freedom mechanical arm, which is not specifically limited herein. For the three-degree-of-freedom mechanical arm, the six-degree-of-freedom mechanical arm, and the seven-degree-of-freedom mechanical arm, reference may be made to the related art, and details are not described again.

In one or more embodiments, the live working robot further includes a surveillance camera. The surveillance camera is arranged on the connection plate 4, and the surveillance camera and the clamping member 5 are located on the same surface of the connection plate 4. The surveillance camera is provided so that the worker facilitates observing the maintenance position of the high-voltage electrical device and the operation state of the maintenance tool of the high-voltage electrical device in real time, whereby the worker can adjust the mechanical arm 2 according to the maintenance state in real time, and thus the maintenance accuracy of the high-voltage electrical device is further ensured.

### Embodiment Two

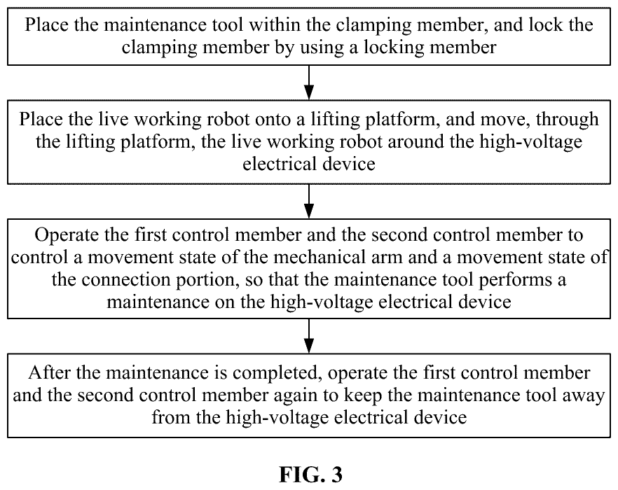

As shown in FIG. 3, this embodiment provides a method for maintaining a high-voltage electrical device. Based on the live working robot in the embodiment one, the method for maintaining the high-voltage electrical device includes the following steps.

The maintenance tool is placed within the clamping member 5, and the clamping member 5 is locked by using a locking member 5. This prevents the maintenance tool from being fallen off when the live working robot maintain the high-voltage electrical device by using the maintenance tool. For the locking member, two relative locking holes may be disposed on the clamping member 5. The locking member is selected as a bolt and a nut. When the maintenance tool is placed into an opening of the clamping member 5 by the worker, the worker makes the bolt penetrate through the locking hole and locks the bolt by using the nut, to lock the clamping member 5.

The live working robot is placed on a lifting platform, and the live working robot is moved around the high-voltage electrical device through the lifting platform. Specifically, the worker controls the height of the lifting platform and adjusts the height position of the live working robot.

The first control unit and the second control unit are operated to control a movement state of the mechanical arm 2 and a movement state of the connection portion 21, so that the maintenance tool performs a maintenance on the high-voltage electrical device. The worker operates the mechanical arm 2 and the connection portion 21 to maintain on the high-voltage electrical device according to the condition of the high-voltage electrical device.

After the maintenance is completed, the first control member and the second control member are operated again to keep the maintenance tool away from the high-voltage electrical device.

According to the method for maintaining the high-voltage electrical device provided in the present disclosure, the maintenance step is simple, the high-voltage electrical device is maintained accurately, and thus the maintenance quality of the high-voltage electrical device is ensured.

Apparently, the above-described embodiments of the present disclosure are merely examples for clearly illustrating the present disclosure and are not intended to limit the embodiments of the present disclosure. Various variations, rearrangements and substitutions may be made by those of ordinary skill in the art without departing from the scope of protection of the present disclosure. This need not be, nor should it be exhaustive of all embodiments. Any modifications, equivalent replacements, and improvements made within the spirit and principle of the present disclosure should be included in the scope of protection of the claims of the present disclosure.

What is claimed is:

1. A live working robot, comprising:
a working bottom plate;
three mechanical arms disposed on the working bottom plate, wherein the three mechanical arms are disposed at intervals around a central axis of the working bottom plate, and the three mechanical arms are provided with connection portions respectively;
three insulating rods, wherein the three insulating rods and the three mechanical arms are disposed in one-to-one correspondence, one end of each of the three insulating rods is connected to a respective one of the connection portions, and each of connection positions between the connection portions and the three insulating rods is adjustable;
a connection plate, wherein one surface of the connection plate is provided with three mounting members, the three mounting members are disposed at intervals around a central axis of the connection plate, the other ends of the three insulating rods are connected to the three mounting members in one-to-one correspondence, and each of the three mounting members is movably connected to a respective one of the three insulating rods; and
a clamping member arranged on another surface of the connection plate and configured to clamp a maintenance tool.

2. The live working robot of claim 1, wherein the connection portions are each a clamping claw; or
the connection portions are electric rotary wheels, circumferential surfaces of the electric rotary wheels are provided with grooves respectively, each of the three insulating rods is arranged within a respective one of the grooves, and each of the electric rotary wheels is configured to perform a forward rotation and a reverse rotation.

3. The live working robot of claim 2, further comprising a control system, wherein the control system comprises a first control member and a second control member, the first control member is configured to control movement of the three mechanical arms, and the second control member is configured to control movement of the connection portions.

4. The live working robot of claim 1, wherein the working bottom plate is configured to perform a self-rotation movement.

5. The live working robot of claim 4, wherein the working bottom plate comprises a bottom plate, a driving member and a rotary plate, the driving member is arranged on the bottom plate, an output end of the driving member is connected to the rotary plate, and the three mechanical arms are disposed on the rotary plate.

6. The live working robot of claim 1, wherein the mounting members are each a universal joint.

7. The live working robot of claim 1, wherein the connection plate is in a regular triangle shape.

8. The live working robot of claim 1, wherein the mechanical arms are each a six-degree-of-freedom mechanical arm.

9. The live working robot of claim 1, further comprising a surveillance camera, wherein the surveillance camera is arranged on the connection plate, and the surveillance camera and the clamping member are located on a same surface of the connection plate.

10. A method for maintaining a high-voltage electrical device, wherein, based on the live working robot of claim 3, the method for maintaining a high-voltage electrical device comprises following steps:
placing the maintenance tool within the clamping member, and locking the clamping member by using a locking member;
placing the live working robot onto a lifting platform, and moving, through the lifting platform, the live working robot around the high-voltage electrical device;
operating the first control member and the second control member to control movement states of the mechanical arms and movement states of the connection portions, so that the maintenance tool performs a maintenance on the high-voltage electrical device; and
after the maintenance is completed, operating the first control member and the second control member again to keep the maintenance tool away from the high-voltage electrical device.

11. The method for maintaining a high-voltage electrical device of claim 10, wherein the working bottom plate is configured to perform a self-rotation movement.

12. The method for maintaining a high-voltage electrical device of claim 11, wherein the working bottom plate comprises a bottom plate, a driving member and a rotary plate, the driving member is arranged on the bottom plate, an output end of the driving member is connected to the rotary plate, and the three mechanical arms are disposed on the rotary plate.

13. The method for maintaining a high-voltage electrical device of claim 10, wherein the mounting members are each a universal joint.

14. The method for maintaining a high-voltage electrical device of claim 10, wherein the connection plate is in a regular triangle shape.

15. The method for maintaining a high-voltage electrical device of claim 10, wherein the mechanical arms are each a six-degree-of-freedom mechanical arm.

16. The method for maintaining a high-voltage electrical device of claim 10, wherein the live working robot further comprises a surveillance camera, wherein the surveillance camera is arranged on the connection plate, and the surveillance camera and the clamping member are located on a same surface of the connection plate.
